(19) United States
(12) Patent Application Publication
(10) Pub. No.: US 2026/0256039 A1
(43) Pub. Date: Sep. 3, 2026

(54) FOLDING PICK-UP ATTACHMENT FOR A HARVESTING MACHINE

(71) Applicant: Carl Geringhoff GmbH & Co. Kommanditgesellschaft, Ahlen (DE)

(72) Inventors: André HEMMESMANN, Sassenberg (DE); Andreas LEUDERALBERT-BOWE, Gronau (DE); Cristiano SCHWARTZ, Ahlen (DE); Holger STRUNK, Wadersloh (DE); Reimer Uwe TIESSEN, Oldenburg (DE)

(73) Assignee: Carl Geringhoff GmbH & Co. Kommanditgesellschaft, Ahlen (DE)

(21) Appl. No.: 18/867,115

(22) PCT Filed: Jun. 20, 2023
(86) PCT No.: PCT/DE2023/100462

§ 371 Date: Nov. 19, 2024

(30) Foreign Application Priority Data
Jun. 22, 2022 (DE) 10 2022 115 512.9

(51) Int. Cl. A01B 73/04; A01D 43/08

(52) U.S. Cl. CPC A01B 73/04; A01D 43/086

(57) ABSTRACT

A folding pick-up attachment for a harvesting machine, preferably for a preferably self-propelled forage harvester, which has a pick-up rotor having pick-up tools for picking crop up from the ground, includes a machine frame that can be folded apart and folded together by way of a folding mechanism, a displacement frame that is arranged on the side of the machine frame that faces toward the rear in the direction of travel, for interaction with the folding mechanism, and is connected to this frame, and an adapter frame that is arranged on the side of the displacement frame that faces to the rear in the direction of travel and is connected to it. The adapter frame has at least one holding point for holding the pick-up attachment using the harvesting machine.

The invention relates to a folding pick-up attachment for a harvesting machine, preferably for a field chopper, in particular for a self-propelled field chopper, comprising a pick-up rotor having pick-up tools for picking crop up from the ground.

Field choppers are harvesting machines that are used for harvesting and collecting crop, cutting crop to short parallel lengths, and conveying the chopped material into containers or separate vehicles. Typical crops are grasses, straw-type crops such as alfalfa or field grass, pulses, mixtures and/or crops grown in rows, such as maize or millet. The chopped material can either be fed to the livestock directly, as fodder, or stored by means of silage or drying, so as to feed it to the livestock later, as fodder. The field chopper can harvest the crop directly, by means of cutting it off over its full width or from individual or multiple rows, or by picking it up from the swath. Field choppers can be attached to a tractor, pulled by a tractor, or self-propelled.

A harvesting attachment is a device, usually removable, for picking up the crop into the field chopper. In the case of a pick-up attachment as a harvesting attachment, this is specifically a device for holding crop that has been cut previously. In this regard, the crop can be laid down in rows or swaths.

In the meantime, self-propelled field choppers have reached a motor power of more than 1,000 HP. Parallel to the motor power, the throughput power of the field choppers has also increased. Aside from the high motor power and throughput power that are required in corn silage, harvesting capacity is a major factor for high fodder quality also in grass silage. After mowing, the meadows and fields must be cleared within a short time window, so as to be able to ensile the green fodder, for example, at an optimal dry-substance content.

In order to be able to make use of the high throughput power of a harvesting machine, in particular of a field chopper, it is necessary, among other things, to clearly increase the forward travel speed of the harvesting machine.

Increasing the working speed or the forward travel speed of the harvesting machine, in particular of the field chopper, as a quasi investment-neutral increase in the impact on or an increase in the harvesting capacity, is accompanied by negative side effects, which will be described in greater detail below.

It is known that harvesting machines, for example field choppers, usually have a contact pressure controller as well as a pendulum plate for height guidance or ground adaptation of the pick-up attachment. However, a contact pressure controller reacts sluggishly, so that it can no longer work effectively and reactively at high forward travel speeds. The result of this is poor ground adaptation of the pick-up attachment, and this-as will be explained in greater detail below-once again leads to harvesting losses or massive fodder contamination and increased machine wear.

If the harvesting machine, in particular the field chopper, travels over a crest at a high forward travel speed, the contact pressure controller cannot lower the pick-up attachment and thereby the pick-up rotor in a timely manner, so that the latter is guided too high for a certain period of time and a certain distance, wherein the pick-up tools, in particular the raking tines of the pick-up rotor no longer reach all the way down to the turf, and this leads to harvesting losses, since crop is not picked up. The result is therefore harvesting losses that remain on the field, since it was not possible to adhere to the optimal raking height.

If the harvesting machine, in particular the field chopper, travels through a dip at an increased forward travel speed, the contact pressure controller cannot raise the pick-up attachment and thereby the pick-up rotor in a timely manner, so that the latter is guided too low for a certain period of time and a certain distance. As a result, the pick-up tools, in particular the raking tines, comb aggressively through the ground or through the turf, and this leads to massive contamination of the crop and thereby to fodder contamination and thus to a reduction in the fodder quality, damage to the turf, and increased wear of both the pick-up attachment and of the harvesting machine, for example the field chopper, since a lot of dirt, in particular sand and soil, is also picked up. Breakage of the pick-up tools, in particular of the raking tines, is also possible.

The drivers of field choppers and transfer vehicles require a clearly greater measure of concentration at higher forward travel speeds, so that the exhaustion limit is reached much sooner. As a result, changes in the contour of the ground, for example caused by trenches, in other words narrow ditches that serve for water drainage between individual fields, by wet spots, or by other barriers are only recognized at a late point in time, and thereby timely, manual adjustment of the forward travel speed as well as of the height of the pick-up attachment is made more difficult.

For the reasons stated above, it is practical to increase the working width of the pick-up attachment, so as to be able to pick up more crop material or harvested mass when traveling over it. As a result, the forward travel speed can be kept at a lower level, and this in turn relieves stress on the driver, increases the fodder quality, prevents increased machine wear, and furthermore is also more fuel-efficient.

In grass silage, in particular, the harvesting capacity is an important factor for high fodder quality. After mowing, the meadows and fields must be cleared within a short time window, so as to be able to ensile the green fodder with an optimal dry substance content, for example. For this reason, the driver of the harvesting machine is under great time pressure in the harvesting chain. Furthermore, in grass harvesting, in particular, the surfaces to be harvested are frequently changed, due to the high impact, so that no time is available for setting up and refitting of the pick-up attachment between road transport and field work. For this reason, wider rigid pick-up attachments do not lead to the desired result, since these have to be removed from the harvesting machine, in particular the field chopper, and loaded onto a transport wagon for the transfer between the different areas. The transport wagon is then coupled to the harvesting machine, in particular the field chopper, and pulled to the next parcel, where once again the pick-up attachment must be installed on the harvesting machine, in particular the field chopper, and set up for use in the field. This process is very time-consuming and impractical.

The better alternative is the use of folding pick-up attachments.

Folding pick-up attachments are known in connection with self-propelled field choppers, for example in the case of maize headers, which are used in silo corn harvesting. Furthermore, folding pick-up attachments are known in connection with self-propelled mowing threshers, for example in the case of maize pickers or grain cutting mechanisms, which are used for harvesting grain maize or grain.

It is advantageous that the set-up times of folding pick-up attachments are significantly shorter than those of rigid, in other words non-folding pick-up attachments, which must be placed on a transport wagon for road transport and pulled to the next field using the harvesting machine, for example the field chopper. It is advantageous that the driver can reversibly pivot the folding pick-up attachment between a working position and a transport position, hydraulically and/or electrically, from the cabin or driver station. In many cases, it is therefore no longer necessary to leave the cabin or get down from the driver station. In the case of folding pick-up attachments, the average set-up time for changing between the two operating states, in other words the working position and the transport position or vice versa, is clearly less than one minute.

When chopping corn or grass crops, above all, the transfer of the crop from the pick-up attachment to the harvesting machine, in particular to the field chopper, has a very important process-technology function. A uniform and process-reliable flow of crop increases the chopping capacity and the chopping quality, and this in turn has an influence on the fodder quality and the productivity. The crop mat must be pre-compressed and transferred directly by the at least one transferring organ of the pick-up attachment, in particular by the transfer tools, for example a transverse conveyor screw, a transfer base or a transfer plane, to the at least one receiving conveying organ of the harvesting machine, in particular of the field chopper, in other words, in particular to a pre-pressing channel or a pre-pressing housing. The compression of the crop mat is not allowed to decrease during the transfer. For this reason, the transfer region or the distance between the transferring and receiving conveying organs must be kept as short as possible.

The disadvantage of folding pick-up attachments, in particular of two-part folding machine frames, is the additional construction space that is required for the folding components. In the case of a two-part folding pick-up attachment, the folding axis in the working position is situated in the direction of travel of the machine center. For the switch between the working position and the transport position, the machine half that is on the right in the direction of travel is folded onto the left machine half and vice versa. For a uniform introduction of load into the harvesting machine, particularly into the pre-pressing housing of the field chopper, the folded pick-up attachment must be arranged symmetrically in front of the harvesting machine, in particular the pre-pressing housing of the field chopper, also in the transport position. In order for the pick-up attachment to be symmetrically arranged in front of the harvesting machine, in particular the pre-pressing housing of the field chopper, in the transport position and in the working position, the machine frame is displaced accordingly during folding, in a displacement frame arranged on the pick-up attachment. The displacement frame therefore holds the two machine halves on its front end, in the direction of travel. An adapter frame is built onto the rear end of the displacement frame, in the direction of travel, with which adapter frame the pick-up attachment is held by the harvesting machine, in particular by the field chopper, by way of at least one holding point. The two machine halves are coupled with one another so as to rotate by way of an axis of rotation, the folding axis. A folding cylinder, which is arranged between the two machine halves, pivots the folding machine half by 180° relative to the pushing machine half. The pushing machine half is displaceably guided in the displacement frame. A control link between the folding machine half and the displacement frame, connected in an articulated manner, displaces the pushing machine half relative to the displacement frame by means of the folding movement, so that the entire pick-up attachment is positioned symmetrically in front of the displacement frame or the field chopper in its end positions, in other words the transport position and the working position. The pushing machine half therefore moves linearly in the displacement frame, and thereby also in front of the contours of the harvesting machine over a certain distance, in particular in front of the pre-pressing housing of the field chopper.

The contours of the harvesting machine, in particular of the pre-pressing housing, for example pre-pressing rollers, holding pockets for the pick-up attachment, as well as drive components or locking components, project through the displacement frame into the construction space region of the machine halves of the pick-up attachment. £ This is not a problem in the case of rigid machine frames or machine frames that fold into three parts, since the center machine frame region can be recessed accordingly and is furthermore arranged fixed in place relative to the contours of the harvesting machine, in particular of the pre-pressing housing, in other words is not displaced relative to the contours of the harvesting machine, in particular relative to the pre-pressing housing. In the case of a machine frame that folds into two parts, one machine half is linearly displaced in front of the contours of the harvesting machine, in particular of the pre-pressing housing, during the switch between the transport position and the working position. As a result, the projecting contours of the harvesting machine, in particular of the pre-pressing housing, are no longer situated fixed in place relative to the pick-up attachment. It is true that here, too, the center machine region can be recessed, so as to create room for the projecting contours of the harvesting machine, in particular of the pre-pressing housing, in particular the pre-pressing channels, in the working position. However, the outer part of the machine half cannot be recessed, so that during displacement of the corresponding machine half, the latter would collide with the corresponding interference contours on the harvesting machine, in particular on the pre-pressing housing of the field chopper.

A collision between the pushing machine half and the interference contours on the harvesting machine, in particular on the pre-pressing housing of the field chopper, can be prevented by configuring the adapter frame and the displacement frame in such a manner that the pushing machine half has a sufficient distance from the harvesting machine, in particular from the pre-pressing housing of the field chopper. The significant disadvantage in this regard is that due to the greater distance of the machine halves from the harvesting machine, in particular from the pre-pressing housing of the field chopper, the at least one conveying organ of the pick-up attachment, in particular the transverse conveying screw, is at a greater distance from the at least one receiving conveying organ of the harvesting machine, in particular the front pre-pressing rollers. As a result, the transfer region between the pick-up attachment and the harvesting machine, in particular the pre-pressing housing of the field chopper, is increased, and this, as has been described above, results in a clear worsening of the crop transfer. As a result, uniform charging of the harvesting machine, in particular of the field chopper, as well as homogeneous compression of the crop mat can no longer be guaranteed, and this in turn leads to a reduction in fodder quality and in productivity.

Proceeding from this state of the art, the invention is based on the task of making available an improved folding pick-up attachment.

This task is accomplished, in the case of a folding pick-up attachment for a harvesting machine, in particular for a preferably self-propelled field chopper, by means of the characteristics of claim 1. Further developments and advantageous embodiments of the invention are evident from the dependent claims.

The folding pick-up attachment according to the invention, for a harvesting machine, preferably for a field chopper, particularly preferably for a self-propelled field chopper, comprises a machine frame that can be unfolded and folded up by way of a folding mechanism, a displacement frame that is arranged on the side of the machine frame that faces to the rear in the direction of travel, in order to interact with the folding mechanism, and is connected to the machine frame, and an adapter frame that is arranged on the side of the displacement frame that faces to the rear in the direction of travel and is connected to it, wherein the adapter frame has at least one holding point for holding the pick-up attachment by means of the harvesting machine, wherein for switching the pick-up attachment from a working position to a transport position, the machine frame and/or the displacement frame can be switched, in particular tilted, from a working position to a transport position, in which the angle and/or the distance of the machine frame and/or of the displacement frame relative to the adapter frame and/or to the harvesting machine, in particular to a receiving conveying organ of the harvesting machine, in particular to a pre-pressing channel or a pre-pressing housing of the harvesting machine, is increased to a predetermined degree, and in which the folding mechanism can be carried out, and wherein in order to switch the pick-up attachment from a transport position to a working position, the machine frame and/or the displacement frame can be switched, in particular tilted, from the transport position, in which the folding mechanism can be carried out, into a working position, in which the angle and/or the distance relative to the adapter frame and/or to the harvesting machine, in particular to the receiving conveying organ of the harvesting machine, in particular to the pre-pressing channel or to the pre-pressing housing of the harvesting machine, is reduced to a predetermined extent.

In other words: Before the folding component of the folding pick-up attachment or of the machine frame folds from a working position into a transport position, wherein usually a pushing component of the folding pick-up attachment or of the machine frame is displaced linearly in front of the harvesting machine, in particular in front of the pre-pressing housing of the field chopper, the machine frame of the pick-up attachment must be switched, in particular tilted out of the original working position into the transport position. By means of the tilting, a greater distance of the machine frame from the harvesting machine, in particular from the pre-pressing housing of the field chopper, is produced, so that the pushing component can be moved, without a collision, in front of the harvesting machine, in particular the pre-pressing housing of the field chopper. Vice versa, after the pick-up attachment, in the stated transport position, has been brought from the transport position into the working position by carrying out the folding mechanism, the machine frame is tilted back into the original working position, so as to once again stand at the least possible distance from the harvesting machine, in particular from the pre-pressing housing of the field chopper.

By means of the change in distance and/or change in angle, according to the invention, between the machine frame and/or displacement frame relative to the adapter frame and/or harvesting machine, a sufficient amount of space is generated between the folding machine frame and the interference contours of the harvesting machine, in particular the pre-pressing housing of the field chopper, so that the folding mechanism can be carried out without collision. While the folding mechanism can be carried out in the transport position according to the invention, this is not the case in the working position according to the invention. For this purpose, the aforementioned distance or angle is reduced to a required minimum in the working position according to the invention, in order to obtain the smallest possible transfer region for the strand of crop between the at least one transferring conveying organ of the pick-up attachment and the at least one receiving conveying organ of the harvesting machine, in particular the pre-pressing housing of the field chopper, during the harvesting process. As a result, the logistical and capacity advantages of a folding pick-up attachment, which is wide in the working position, can be combined with the process technology advantages of the smallest possible transfer region between the dispensing and the receiving conveying organs.

Furthermore, the aforementioned change in distance and/or angle increases the distance of the folding machine frame relative to the driver cabin or the driver station of the harvesting machine, so that here, too, collisions during the folding process, between folding parts of the pick-up attachment and components of the harvesting machine, in particular of the field chopper, can be precluded. The same holds true for pick-up attachments that are folded in the transport position, which no longer collide with the driver cabin or the driver station when the pre-pressing housing is completely lifted out, by means of corresponding measures that increase the distance and/or angle.

The adapter frame is a frame that is preferably installed on the displacement frame of the folding pick-up attachment. By way of this adapter frame or installed frame, the folding pick-up attachment is held and carried by the harvesting machine. In this regard, the harvesting machine can also be referred to as a carrier vehicle.

It can be advantageous if the displacement frame and the adapter frame are configured in such a manner that in the working position, the distance between a transferring conveying organ, in particular of a transverse conveying screw, or a transfer bottom or a transfer plane of the pick-up attachment, which transfers a crop strand to the harvesting machine in the working position, and the receiving conveying organ, in particular the pre-pressing channel or housing of the harvesting machine, which receives the crop strand from the pick-up attachment in the working position, is so slight that the crop strand remains uniformly homogeneously compressed during transfer and acceptance.

It can be advantageous if the machine frame is recessed in such a manner that in the working position, it does not collide with projecting contours of the harvesting machine, in particular of the receiving conveying organ of the harvesting machine, in particular the pre-pressing channel or the pre-pressing housing of the harvesting machine.

It can be advantageous if the machine frame is configured to fold in multiple parts, preferably in two parts, wherein for this purpose the machine frame has a folding machine half and a pushing machine half, which are coupled with one another, and wherein at least the pushing machine half can be displaced in the displacement frame, preferably in a linear manner, wherein in the transport position the folding machine half can be folded onto the pushing machine half, about a folding axis or axis of rotation that runs in the direction of travel, between the machine halves.

It can be advantageous if at least one, preferably only one folding cylinder is provided, which is arranged between the two machine halves and pivots the folding machine half by 180° relative to the pushing machine half.

It can be advantageous if at least one, preferably only one control link is provided, which is connected, in an articulated manner, between the folding machine half and the displacement frame, and displaces the pushing machine half relative to the displacement frame by means of the folding movement, so that the entire pick-up attachment is symmetrically positioned in front of the displacement frame or the harvesting machine in its end positions, in other words the transport position and the working position.

It can be advantageous if the displacement frame is connected to the adapter frame by way of an axis of rotation, wherein the displacement frame and thereby the machine frame of the pick-up attachment can be tilted relative to the adapter frame and thereby to the harvesting machine that can be connected to the adapter frame.

It can be advantageous if the axis of rotation, in a neutral position of the pick-up attachment, is oriented horizontally relative to the plane of a substratum or of the ground.

It can be advantageous if the axis of rotation is arranged at the level of the transfer base or the transfer plane of the pick-up attachment.

It can be advantageous if at least one, preferably multiple actuators that are arranged transverse to the direction of travel and spaced apart from one another are provided above and at a distance from the axis of rotation, in other words on the side of the axis of rotation that faces away from the substratum or ground, in particular hydraulic cylinders, linear motors and/or threaded spindles, which couple the adapter frame to the displacement frame.

By means of a change in length of the actuators, tilting of the displacement frame and thereby of the machine frame of the pick-up attachment, about the axis of rotation and relative to the adapter frame and thereby to the harvesting machine is achieved. The resulting increase in distance between the adapter frame or harvesting machine and the displacement frame and machine frame is sufficient to guarantee collision-free displacement of the displaceable components of the machine frame, preferably of the pushing machine half, relative to the projecting contours of the harvesting machine, in particular of the pre-pressing channel or the pre-pressing housing of the field chopper.

It can be advantageous if the predetermined tilt angle of the displacement frame and thereby of the machine frame can be adjusted relative to the adapter frame and thereby relative to the harvesting machine, preferably by means of the at least one actuator, from a central location, preferably from the driver station of the harvesting machine.

It can be advantageous if the pushing machine half can be linearly guided on the displacement frame, wherein the linear guide forms an axis of rotation, by means of which the machine frame can be tilted relative to the displacement frame and thereby relative to the adapter frame and thereby relative to the harvesting machine that can be connected to the adapter frame.

It can be advantageous if the axis of rotation is configured in that the pushing machine half, in the lower region, has a round, linear guide track or guide rail, in particular a tube or a shaft, which is preferably arranged below the transfer base or the transfer plane of the pick-up attachment, and that preferably the displacement frame and/or the adapter frame has/have preferably concave-shaped guide rollers that are arranged transverse to the direction of travel and preferably aligned relative to the substratum plane or ground plane or arranged in a line as well as arranged at a distance from one another, in which rollers the pushing machine half runs with its guide track or guide rail.

It can be advantageous if the axis of rotation is oriented horizontally relative to the plane of a substratum or ground, in a neutral position of the pick-up attachment.

It can be advantageous if the pushing machine half has a round linear guide track or guide rail, in particular a tube or a shaft, in the upper region, and that the displacement frame and/or preferably the adapter frame has/have concave-shaped guide rollers that are arranged transverse to the direction of travel and preferably aligned relative to the substratum plane or ground plane or arranged in a line as well as arranged at a distance from one another, in which rollers the pushing machine half runs with its guide track or guide rail, wherein the guide track or guide rail provided in the upper region is configured in such a manner that during displacement of the pushing machine half on the lower linear guide rail, transverse to the direction of travel, and thereby during folding, the pushing machine half can be tilted about the axis of rotation or the guide track provided in the lower region, wherein the guide track provided in the upper region preferably has a contour oriented transverse to the direction of travel and approximately perpendicular to the folding axis, which contour is suitable for tilting, preferably an arc-shaped contour or a semi-arc-shaped contour. The resulting increase in distance between the machine frame and the displacement frame or adapter frame or harvesting machine is sufficient to guarantee collision-free displacement of the displaceable component of the machine frame, preferably of the pushing machine half, relative to the projecting contours of the harvesting machine, in particular of the pre-pressing channel or the pre-pressing housing of the field chopper.

It can be advantageous if the dimension or the degree of tilting can be controlled by means of the shape of the arc or the semi-arc.

It can be advantageous if the predetermined change in distance of the machine halves and of the displacement frame, relative to the adapter frame and/or the harvesting machine, in particular relative to the receiving conveying organ of the harvesting machine, in particular to the pre-pressing channel or to the pre-pressing housing of the harvesting machine, can be achieved in that the adapter frame and the displacement frame are connected to one another with one or more control links that can pivot, in an articulated manner.

It can be advantageous if the control links are attached in the region of the lower and upper corner points of the displacement frame and of the adapter frame.

It can be advantageous if the control links are oriented in any desired orientation, for example horizontal to or vertical to the substratum plane or ground plane, but preferably horizontal to the plane of the substratum or of the ground.

It can be advantageous if the change in distance between the displacement frame and the adapter frame is configured as a parallel displacement, controlled by the control links, wherein at least one, preferably multiple of the actuators that are arranged transverse to the direction of travel and spaced apart from one another, in particular hydraulic cylinders, linear motors and/or threaded spindles, are provided for carrying out the parallel displacement.

It can be advantageous if the at least one actuator can be changed, in terms of length, electrically, hydraulically and/or mechanically.

It can be advantageous if the at least one actuator can be controlled and/or regulated electrically and/or hydraulically, preferably from a central location, preferably from the driver station of the harvesting machine.

It can be advantageous if the change in distance and/or change in angle or tilting from the working position into the transport position and vice versa, according to the invention, can be carried out as sequential control of the folding process/procedure.

It can be advantageous if the aforementioned possibility of the change in distance and/or the change in angle or tilting can be carried out in different combinations.

It can also be advantageous if the pick-up attachment is configured to fold in three parts or fold in multiple parts. To the extent that a pushing or folding machine half was mentioned above, this would then be understood to be a pushing or folding machine component in the case of a three-part folding or multi-part folding pick-up attachment.

After all this, the following advantages of a folding pick-up attachment according to the invention, for a field chopper, exist as compared with the state of the art:
increasing the harvesting capacity by means of an increase in the working width,
increasing the productivity or reducing the set-up times of a wide pick-up attachment, in that the latter is configured to fold,
improving the crop flow and thereby the fodder quality as well as the productivity, in that a two-part folding pick-up attachment has a small distance between the transfer organs in the working position, in other words a small transfer region between the transverse conveying screw of the pick-up attachment and the pre-pressing rollers of the field chopper,
combining the logistical and capacitive advantages of a folding and wide pick-up attachment with the process technology advantages of a rigid, in other words a non-folding pick-up attachment, due to the possibility of optimally positioning the folding pick-up attachment in front of the pre-pressing housing of the field chopper.

Further characteristics of the invention are evident from the claims, the figures, and the figure description. £ All of the characteristics and combinations of characteristics mentioned above in the specification, as well as the characteristics and combinations of characteristics mentioned below, in the figure description, and/or only shown in the figures, can be used not only in the combination indicated, in each instance, but also in other combinations or by themselves.

The invention will now be explained in greater detail using preferred exemplary embodiments and making reference to the attached drawings. These show:

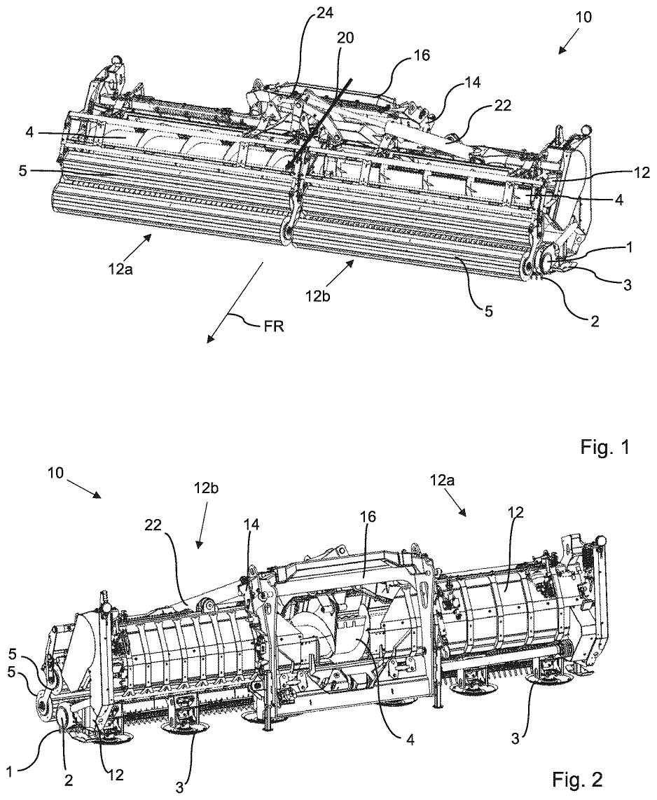

FIG. 1 a perspective view of a folding pick-up attachment from the front, in a working position,

FIG. 2 a perspective view of the folding pick-up attachment shown in FIG. 1, from the rear, in a working position,

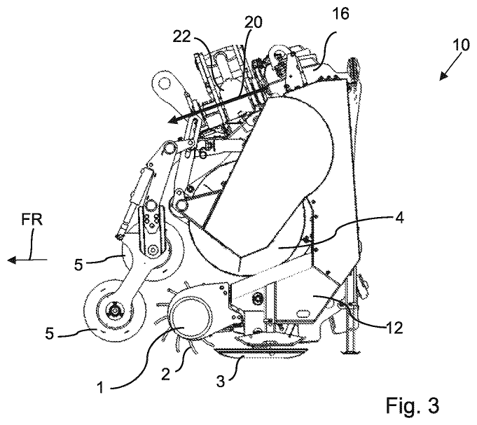

FIG. 3 a side view of the folding pick-up attachment shown in FIG. 1,

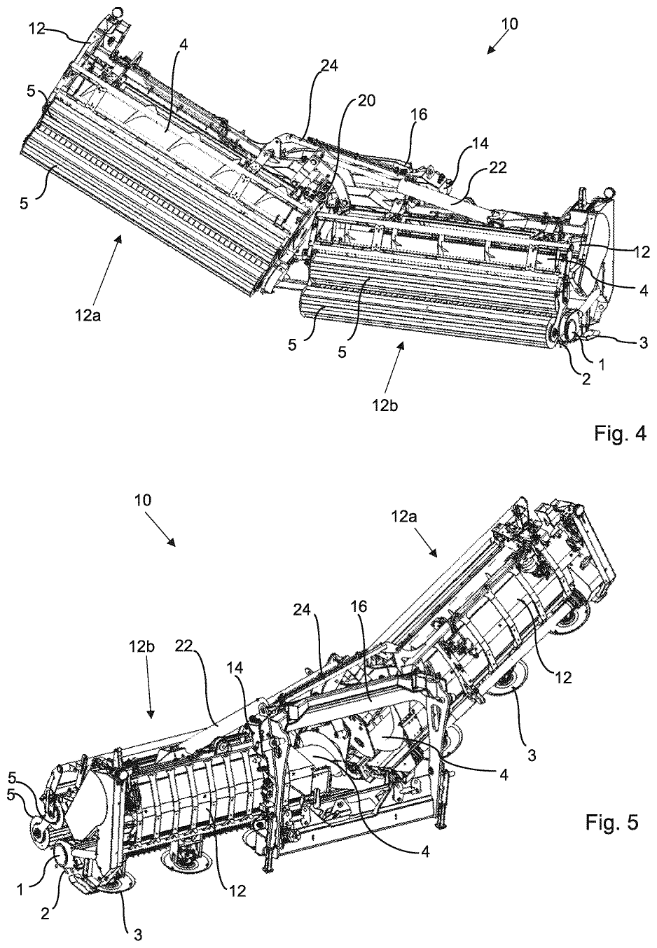

FIG. 4 a perspective view of the folding pick-up attachment shown in FIG. 1, from the front, during the starting phase of the folding process, from the working position into the transport position,

FIG. 5 a perspective view of the folding pick-up attachment shown in FIG. 4 from the rear,

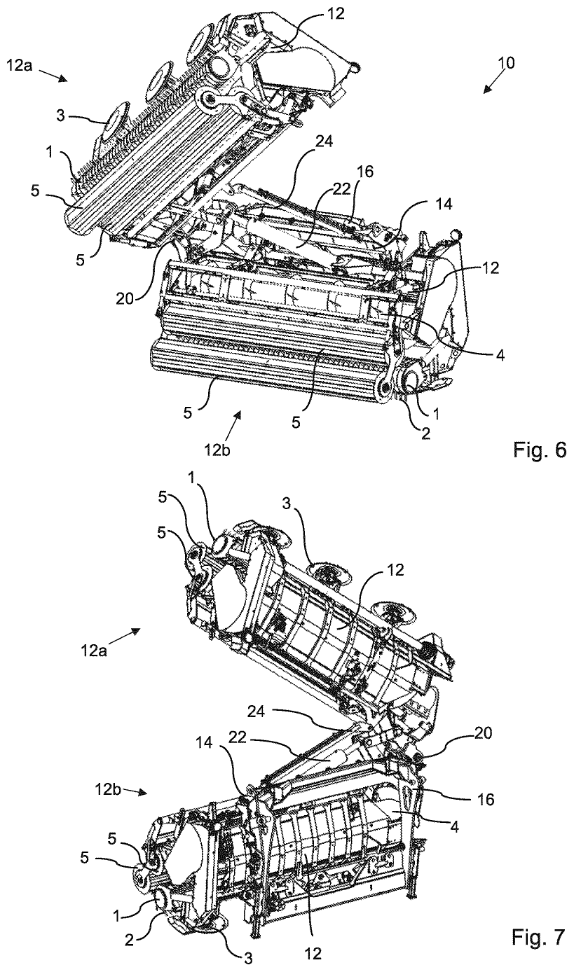

FIG. 6 a perspective view of the folding pick-up attachment shown in FIG. 1 from the front, during an advanced phase of the folding process, from the working position into the transport position,

FIG. 7 a perspective view of the folding pick-up attachment shown in FIG. 6 from the rear,

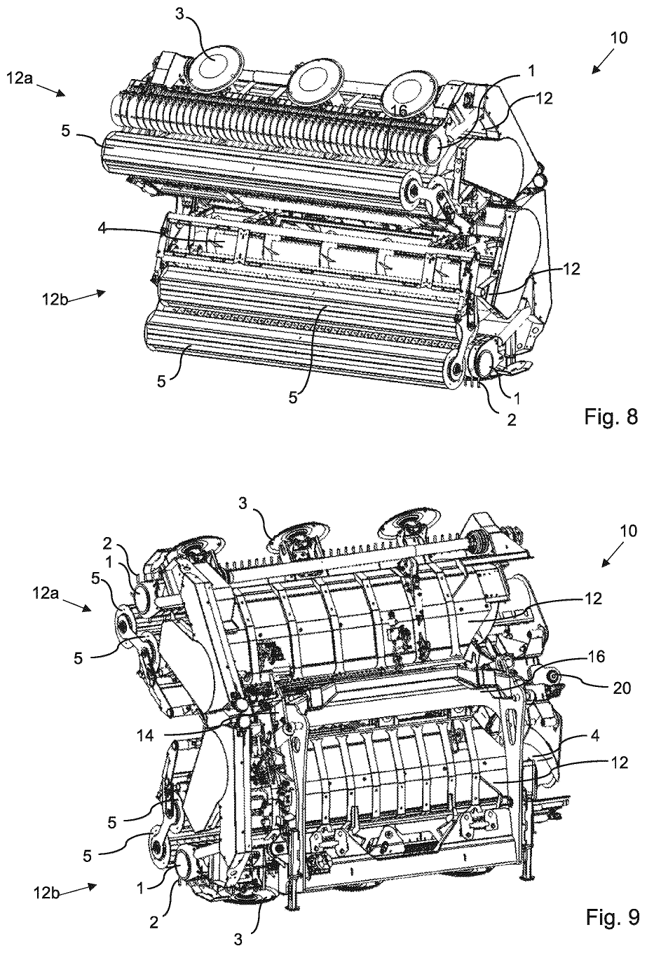

FIG. 8 a perspective view of the folding pick-up attachment shown in FIG. 1 from the front, in the transport position at the end of the folding process,

FIG. 9 a perspective view of the folding pick-up attachment shown in FIG. 8 from the rear,

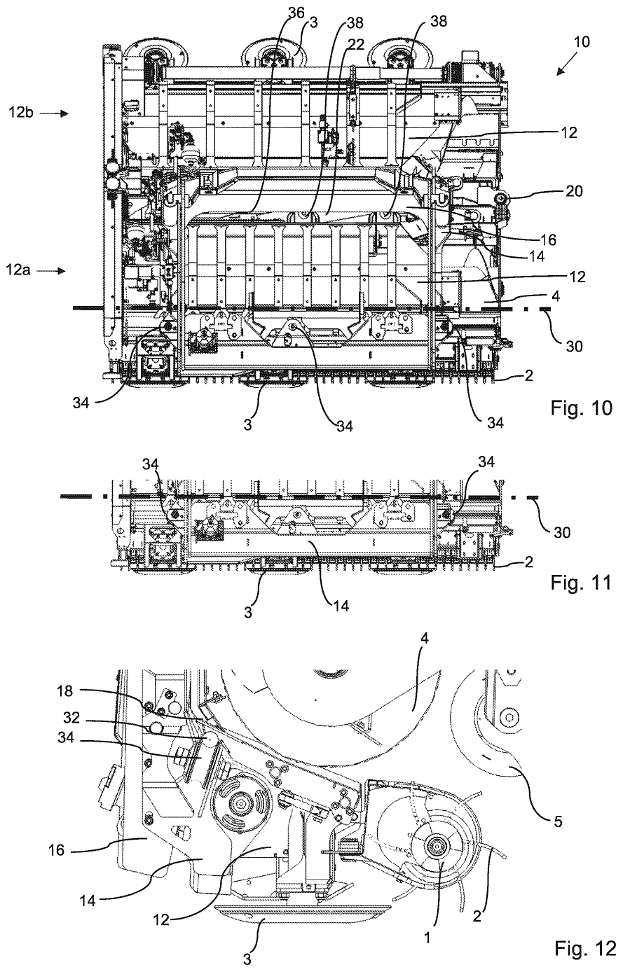

FIG. 10 a view of the folding pick-up attachment in the transport position, from the rear, in which an axis of rotation between the machine frame and the displacement frame is formed by a guide rail and guide rollers,

FIG. 11 a detail view of the folding pick-up attachment according to FIG. 10, in the transport position, from the rear, in which an axis of rotation between the machine frame and the displacement frame is formed by a guide rail and guide rollers,

FIG. 12 a perspective detail view of a guide rail and a guide roller of the folding pick-up attachment shown in FIG. 10,

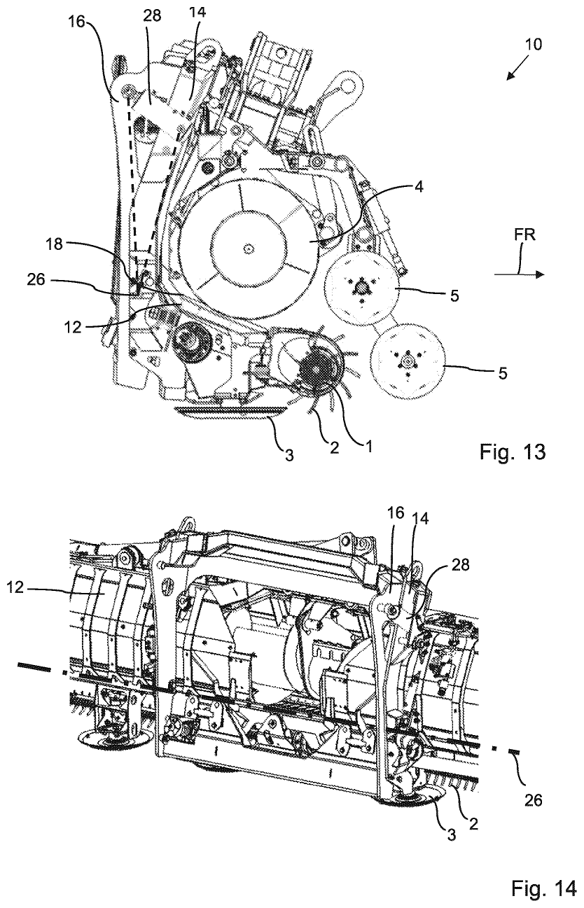

FIG. 13 a side view of a folding pick-up attachment, in which an axis of rotation is formed between the adapter frame and the displacement frame, in the starting position,

FIG. 14 a perspective view of the folding pick-up attachment according to FIG. 13, from the rear,

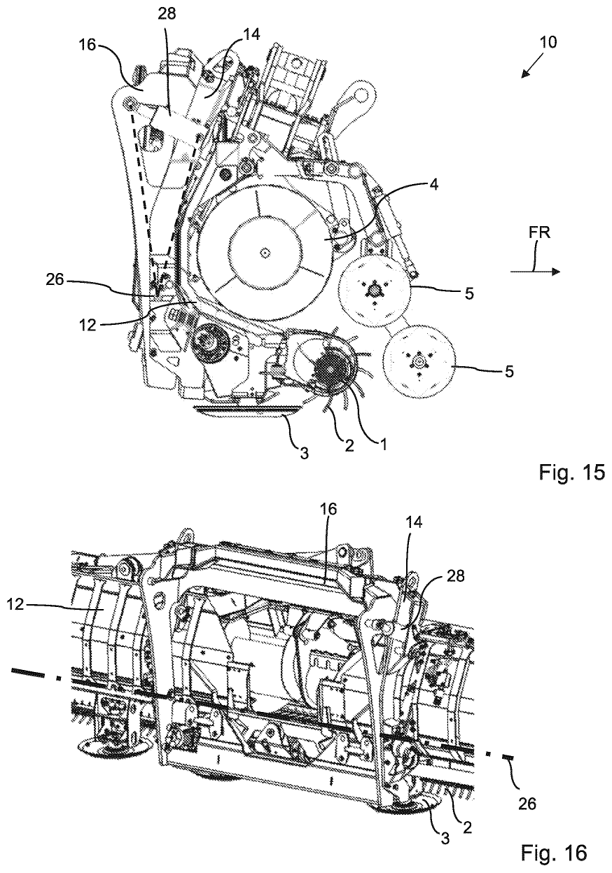

FIG. 15 a side view of the folding pick-up attachment according, in which an axis of rotation is formed between the adapter frame and the displacement frame, in an advanced tilted position,

FIG. 16 a perspective view of the folding pick-up attachment according to FIG. 15 from the rear,

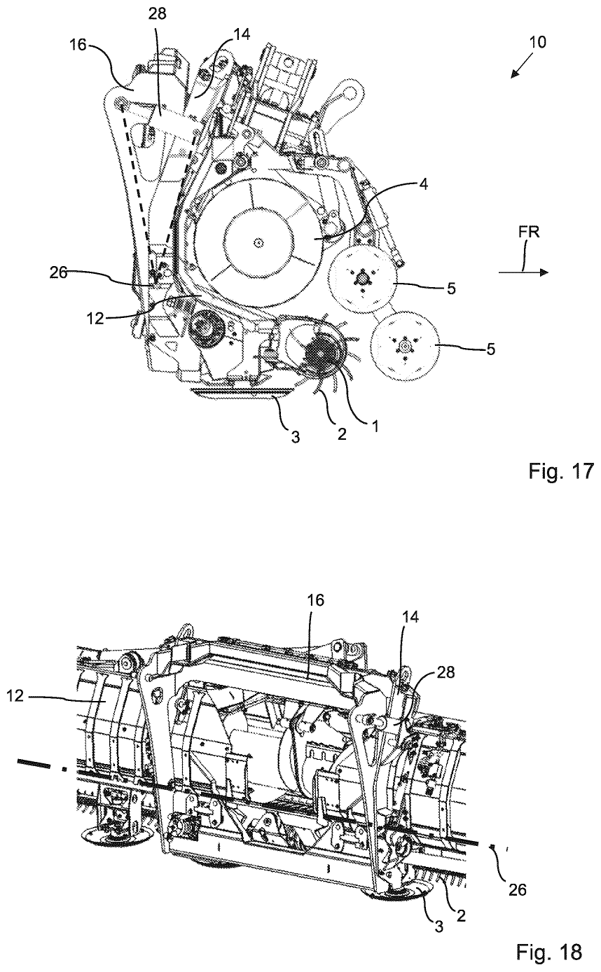

FIG. 17 a side view of the folding pick-up attachment according to FIG. 13, in which an axis of rotation is formed between the adapter frame and the displacement frame, in a more advanced tilted position, and

FIG. 18 a perspective view of the folding pick-up attachment according to FIG. 17 from the rear.

If the same reference numbers are used in FIG. 1 to 18, they also refer to the same parts or regions.

FIGS. 1 and 2 show, in a perspective view, in each instance, a folding pick-up attachment 10, for one thing from the front, in other words counter to the direction of travel FR, and for another thing from the rear, in other words in the direction of travel FR. In FIG. 3, a side view of the folding pick-up attachment 10 according to FIG. 1 is shown schematically.

The folding pick-up attachment 10 for a self-propelled field chopper, which is not shown here, comprises a machine frame 12 that carries two machine halves 12a, 12b, which can be folded apart and folded together by way of a folding mechanism.

Each machine half comprises a pick-up rotor 1 having pick-up tools 2, which are configured as raking tines in the present case, for picking crop up from the ground, wherein each pick-up rotor 1 is connected to three guide elements 3 that lie on the ground or substratum, which elements are configured, in the present case, as slide plates. The guide elements 3 take on the guidance of the pick-up rotor 1 and guide it to the ground. The ground usually forms the turf. Furthermore, each machine half 12a, 12b has a transverse conveying screw 4 that transfers the picked-up crops as a crop mat. Furthermore, each machine half 12a, 12b comprises what are called hold-downs 5, preferably in the form of rollers, which predetermine the direction of the crop flow when the crop is conveyed upward, with great acceleration, due to the rotating pick-up tools 2.

The pick-up attachment 10 furthermore comprises a displacement frame 14 that is arranged on the side of the machine frame 12 that faces toward the rear in the direction of travel FR and connected to this frame, for participation in the folding mechanism, and an adapter frame 16 that is arranged on the side of the displacement frame 14 that faces toward the rear in the direction of travel FR and connected to it. By way of the adapter frame 16, which can also be referred to as a mounting frame, the folding pick-up attachment 10 is held and carried by the field chopper.

In the case of the present two-part folding pick-up attachment 10, the folding axis 20 is in the working position, in other words in the machine center or in the center of the machine frame 12, in the direction of travel FR, when the machine halves 12a, 12b are folded out. As shown in different views and phases in FIG. 4 to 9, the machine half 12a that is on the right in the direction of travel FR is folded onto the left machine half 12b for the switch between the working position and the transport position. For a uniform introduction of load into the pre-pressing housing of the field chopper, the folded-up pick-up attachment 10 must be arranged symmetrically in front of the pre-pressing housing of the field chopper also in the transport position. In order for the pick-up attachment 10 to be arranged symmetrically in front of the pre-pressing housing of the field chopper in the transport position and the working position, the machine frame 12 is displaced accordingly in the displacement frame 14 during the folding process. For this purpose-as has been explained-the displacement frame 14 holds the two machine halves 12a, 12b on its end that is in the front in the direction of travel FR. As has been explained-the adapter frame 16 is built onto the end of the displacement frame 14 that is in the rear in the direction of travel FR. The two machine halves 12a, 12b are coupled with one another, so as to rotate, by way of the axis of rotation or folding axis 20. A folding cylinder 22 that is arranged between the two machine halves 12a, 12b pivots the folding machine half 12a by 180° relative to the pushing machine half 12b. The pushing machine half 12b is displaceably guided in the displacement frame 14. A control link 24 between the folding machine half 12a and the displacement frame 14, which link is connected in an articulated manner, displaces the pushing machine half 12b relative to the displacement frame 14 by means of the folding movement, so that the entire pick-up attachment is symmetrically positioned in front of the displacement frame 14 or the field chopper in its end positions, in other words the transport position and the working position. The pushing machine half 12b is therefore linearly moved in the displacement frame 14.

In the case of the present two-part folding machine frame 12, the pushing machine half 12b is linearly displaced in front of the pre-pressing housing of the field chopper during the change between the transport position and the working position. As a result, the projecting contours of the pre-pressing housing are exposed to collisions if the distance that must be maintained between the conveying organ of the pick-up attachment that transfers the crop, in particular the transverse conveying screw 4, and the receiving conveying organ of the harvesting machine, in particular the front pre-pressing rollers of the pre-pressing housing, is so small that homogeneous compression of the crop mat is guaranteed at transfer.

According to the invention, it is provided that for switching the pick-up attachment 10 from the working position to the transport position, the machine frame 12 or the two machine halves 12a, 12b and/or the displacement frame 14 can be changed, in particular tilted, from a working position to a transport position, in which the angle and/or the distance of the machine frame 12 or of the two machine halves 12a, 12b and/or of the displacement frame 14 relative to the adapter frame 16 and/or to the pre-pressing channel or pre-pressing housing of the field chopper is/are increased to a predetermined extent, and in which the folding mechanism can be carried out without collisions, and wherein in order to switch the pick-up attachment 10 from the transport position to the working position, the machine frame 12 or the machine halves 12a, 12b and/or the displacement frame 14 can be switched, in particular tilted, from the transport position, in which the folding mechanism can be carried out without collisions, into the working position, in which the angle and/or the distance relative to the adapter frame 16 and/or to the pre-pressing housing of the field chopper has been reduced to a predetermined extent.

The displacement frame 14 and the adapter frame 16 are configured in such a manner that in the working position, the distance between a transferring conveying organ, in other words the transverse conveying screw 4 and the transfer base or the transfer plane 18 of the pick-up attachment 10, which organ transfers a crop strand to the harvesting machine in the working position, and the receiving conveying organ, not shown here, in other words the pre-pressing housing of the field chopper, which receives the crop strand from the pick-up attachment 10 in the working position, is so slight that the crop strand remains uniformly homogeneously compressed during the transfer and the acceptance.

The machine frame 12 is recessed in such a manner that it does not collide with contours of the pre-pressing housing of the field chopper in the working position.

To produce the change in distance and/or angle according to the invention, between the machine halves 12a, 12b and the displacement frame 14, the pushing machine half 12b—as shown in FIG. 10-13—can be linearly guided on the displacement frame 14, wherein the linear guide forms an axis of rotation 30, and thereby the machine frame 12 can be tilted relative to the displacement frame 14 and thereby relative to the adapter frame 16 and thereby relative to the field chopper that can be connected to the adapter frame 16. The axis of rotation 30 is formed in that the pushing machine half 12b has a round linear guide track or guide rail 32 in the form of a rod in the lower region, which track or guide is preferably arranged below the transfer base or the transfer plane 18 of the pick-up attachment 10. The displacement frame 14 has concave-shaped guide rollers 34 that are arranged transverse to the direction of travel FR and aligned relative to the substratum plane or ground plane or arranged in a line as well as arranged at a distance from one another, in which rollers the pushing machine half 12b runs with its guide track or guide rail 32. In a neutral position of the pick-up attachment 10, the axis of rotation 30 is oriented horizontal to the plane of a substratum or ground. Furthermore, the pushing machine half 12b has a round linear guide track or guide rail 36 in the form of a rod in the upper region. The adapter frame 16 has concave-shaped guide rollers 38 that are arranged transverse to the direction of travel FR and aligned relative to the substratum plane or ground plane or arranged in a line as well as arranged at a distance from one another, in which rollers the pushing machine half 12b runs with its guide track or guide rail 32, wherein the guide rail or guide track 36 arranged in the upper region is structured in such a manner that during displacement of the pushing machine half 12b on the lower linear guide rail 32 transverse to the direction of travel FR, and thereby during folding, the pushing machine half 12b can be tilted about the axis of rotation 30 or about the guide track provided in the lower region, wherein the guide track provided in the upper region has a contour oriented transverse to the direction of travel FR and approximately perpendicular to the folding axis 20, which contour is suitable for tilting, preferably an arc-shaped contour or a semi-arc-shaped contour.

To produce the change in distance and/or angle according to the invention, the displacement frame 14 can also—as shown in FIG. 13-18—be connected to the adapter frame 16 by way of an axis of rotation 26, wherein the displacement frame 14 and thereby the machine frame 12 of the pick-up attachment 10 can be tilted relative to the adapter frame 16 and thereby relative to the field chopper that can be connected to the adapter frame 16. The axis of rotation 26 is oriented horizontal to the plane of a substratum or ground in a neutral position of the pick-up attachment 10, and arranged at the level of the transfer base or the transfer plane 18 of the pick-up attachment 10. Above and at a distance from the axis of rotation 26, in other words on the side of the axis of rotation 26 that faces away from the substratum or ground, multiple actuators 28 arranged transverse to the direction of travel and at a distance from one another, in the present case hydraulic cylinders, are provided, which couple the adapter frame 16 to the displacement frame 14. The predetermined tilting angle of the displacement frame 14 and thereby of the machine frame 12 relative to the adapter frame 16 and thereby relative to the field chopper can be adjusted by means of the actuators 28, from the driver station. The broken lines serve to better identify the tilt angle that changes during tilting.

### REFERENCE SYMBOL LIST

1 pick-up rotor
2 pick-up tool
3 guide element
4 transverse conveying screw
5 hold-down roller
10 pick-up attachment
12 machine frame
12a folding machine half
12b pushing machine half
14 displacement frame
16 adapter frame
18 transfer plane
20 folding axis or axis of rotation
22 folding cylinder
24 control link
26 axis of rotation
28 actuator
30 axis of rotation
32 guide rail
34 guide roller
36 guide rail
38 guide roller
FR direction of travel

1. A folding pick-up attachment (10) for a harvesting machine, preferably for a field chopper, particularly preferably for a self-propelled field chopper, which has a pick-up rotor having pick-up tools for picking crop up from the ground, comprising a machine frame (12) that can be folded apart and folded together by way of a folding mechanism, a displacement frame (14) that is arranged on the side of the machine frame (12) that faces toward the rear in the direction of travel (FR), for interaction with the folding mechanism, and is connected to this frame, and an adapter frame (16) that is arranged on the side of the displacement frame (14) that faces to the rear in the direction of travel (FR) and is connected to it, wherein the adapter frame (16) has at least one holding point for holding the pick-up attachment (10) by means of the harvesting machine, wherein for changing the pick-up attachment (10) from a working position into a transport position, the machine frame (12) and/or the displacement frame (14) can be changed, in particular tilted from a working position into a transport position, in which the angle and/or the distance of the machine frame (12) and/or of the displacement frame (14) relative to the adapter frame (16) and/or to the harvesting machine, in particular to a receiving conveying organ of the harvesting machine, in particular to a pre-pressing channel or a pre-pressing housing of the harvesting machine, is/are increased to a predetermined degree, and in which the folding mechanism can be carried out, and wherein in order to switch the pick-up attachment (10) from a transport position to a working position, the machine frame (12) and/or the displacement frame (14) can be switched, in particular tilted, from the transport position, in which the folding mechanism can be carried out, into a working position, in which the angle and/or the distance relative to the adapter frame (16) and/or to the harvesting machine, in particular to the receiving conveying organ of the harvesting machine, in particular to the pre-pressing channel or to the pre-pressing housing of the harvesting machine, is reduced to a predetermined extent.

2. The folding pick-up attachment (10) according to claim 1, wherein the displacement frame (14) and the adapter frame (16) are configured in such a manner that in the working position, the distance between a transferring conveying organ, in particular a transfer base or a transfer plane (18), of the pick-up attachment (10), which transfers a crop strand to the harvesting machine in the working position, and the receiving conveying organ, in particular the pre-pressing channel or pre-pressing housing of the harvesting machine, which receives the crop strand from the pick-up attachment (10) in the working position, is so slight that the crop strand remains uniformly homogeneously compressed during the transfer and acceptance.

3. The folding pick-up attachment (10) according to claim 2, wherein the machine frame (12) is recessed in such a manner that, in the working position, the machine frame (12) does not collide with contours of the harvesting machine, in particular of the receiving conveying organ of the harvesting machine, in particular of the pre-pressing channel or of the pre-pressing housing of the harvesting machine.

4. The folding pick-up attachment (10) according to claim 1, wherein the machine frame (12) is configured to fold in multiple parts, preferably in two parts, wherein for this purpose the machine frame (12) has a folding machine half (12a) and a pushing machine half (12b), which are coupled with one another, and wherein at least the pushing machine half (12b) can be displaced in the displacement frame (14), preferably in a linear manner, wherein in the transport position the folding machine half (12a) can be folded onto the pushing machine half (12b), about a folding axis or axis of rotation (20) that runs in the direction of travel, between the machine halves (12a, 12b).

5. The folding pick-up attachment (10) according to claim 1, wherein at least one, preferably only one folding cylinder (22) is provided, which is arranged between the two machine halves (12a, 12b) and pivots the folding machine half (12 a) by 180° relative to the pushing machine half (12b).

6. The folding pick-up attachment (10) according to claim 1, wherein at least one, preferably only one control link (24) is provided, which is connected, in an articulated manner, between the folding machine half (12a) and the displacement frame (14), and displaces the pushing machine half (12b) relative to the displacement frame (14) by means of the folding movement, so that the entire pick-up attachment (10) is symmetrically positioned in front of the displacement frame (14) or the harvesting machine in its end positions, in other words the transport position and the working position.

7. The folding pick-up attachment (10) according to claim 1, wherein the displacement frame (14) is connected to the adapter frame (16) by way of an axis of rotation (26), wherein the displacement frame (14) and thereby the machine frame (12) of the pick-up attachment (10) can be tilted relative to the adapter frame (16) and thereby relative to the harvesting machine that can be connected to the adapter frame (16).

8. The folding pick-up attachment (10) according to claim 7, wherein the axis of rotation (26) is oriented horizontally relative to the plane of a substratum or of the ground in a neutral position of the pick-up attachment (10).

9. The folding pick-up attachment (10) according to claim 7, wherein the axis of rotation (26) is arranged at the level of the transfer base or of the transfer plane (18) of the pick-up attachment (10).

10. The folding pick-up attachment (10) according claim 1, wherein at least one, preferably multiple actuators (28) that are arranged transverse to the direction of travel and spaced apart from one another are provided above and at a distance from the axis of rotation (26), in other words on the side of the axis of rotation (26) that faces away from the substratum or ground, in particular hydraulic cylinders, linear motors and/or threaded spindles, which couple the adapter frame (16) to the displacement frame (14).

11. The folding pick-up attachment (10) according claim 1, wherein the predetermined tilt angle of the displacement frame (14) and thereby of the machine frame (12) can be adjusted relative to the adapter frame (16) and thereby relative to the harvesting machine, preferably by means of the at least one actuator (28), from a central location, preferably from the driver station of the harvesting machine.

12. The folding pick-up attachment (10) according to claim 1, wherein the pushing machine half (12b) can be linearly guided on the displacement frame (14), wherein the linear guide forms an axis of rotation (30), by means of which the machine frame (12) can be tilted relative to the displacement frame (14) and thereby relative to the adapter frame (16) and thereby relative to the harvesting machine that can be connected to the adapter frame (16).

13. The folding pick-up attachment (10) according to claim 12, wherein the axis of rotation (30) is configured in that the pushing machine half (12b) has a round linear guide track or guide rail (32), in particular a tube or a shaft, in the lower region, which is preferably arranged below the transfer base or the transfer plane (18) of the pick-up attachment (10), and wherein preferably, the displacement frame (14) and/or the adapter frame (16) has preferably concave-shaped guide rollers (34) that are arranged transverse to the direction of travel (FR) and preferably aligned relative to the substratum plane or ground plane or arranged in a line as well as arranged at a distance from one another, in which rollers the pushing machine half (12b) runs with its guide track or guide rail (32).

14. The folding pick-up attachment (10) according to claim 12, wherein the axis of rotation (30) is oriented horizontally relative to the plane of a substratum or ground, in a neutral position of the pick-up attachment (10).

15. The folding pick-up attachment (10) according to claim 1, wherein the pushing machine half (12b) has a round linear guide track or guide rail (36), in particular a tube or a shaft, in the upper region, and wherein the displacement frame (14) and/or preferably the adapter frame (16) has/have concave-shaped guide rollers (38) that are arranged transverse to the direction of travel (FR) and preferably aligned relative to the substratum plane or ground plane or arranged in a line as well as arranged at a distance from one another, in which rollers the pushing machine half (12b) runs with its guide track or guide rail (36), wherein the guide track or guide rail (36) provided in the upper region is configured in such a manner that during displacement of the pushing machine half (12b) on the lower linear guide rail (32), transverse to the direction of travel (FR), and thereby during folding, the pushing machine half (12b) can be tilted about the axis of rotation (30) or the guide track provided in the lower region, wherein the guide track provided in the upper region preferably has a contour oriented transverse to the direction of travel (FR) and approximately perpendicular to the folding axis (20), which contour is suitable for tilting, preferably an arc-shaped contour or a semi-arc-shaped contour.

16. The folding pick-up attachment (10) according to claim 15, wherein the extent or the degree of tilting can be controlled by means of configuring the arc-shaped or semi-arc-shaped shape.

17. The folding pick-up attachment (10) according to claim 1, wherein the predetermined change in distance of the machine halves (12a, 12b) and of the displacement frame (14) relative to the adapter frame (16) and/or to the harvesting machine, in particular to the receiving conveying organ of the harvesting machine, in particular to the pre-pressing channel or to the pre-pressing housing of the harvesting machine, can be achieved in that the adapter frame (16) and the displacement frame (14) are connected with one another, in an articulated manner, with one or more pivoting links.

18. The folding pick-up attachment (10) according to claim 17, wherein the links are attached in the region of the lower and upper corner points of the displacement frame (14) and of the adapter frame (16).

19. The folding pick-up attachment (10) according to claim 17, wherein the links are oriented in any desired orientation, for example horizontal or vertical to the substratum plane or ground plane, but preferably horizontal to the plane of the substratum or ground.

20. The folding pick-up attachment (10) according to claim 17, wherein the change in the distance between the displacement frame (14) and the adapter frame (16) is formed as a parallel displacement, controlled by the links, wherein at least one actuator, preferably multiple actuators arranged transverse to the direction of travel and spaced apart from one another, in particular hydraulic cylinders, linear motors and/or threaded spindles, are provided for carrying out the parallel displacement.

21. The folding pick-up attachment (10) according to claim 1, wherein the at least one actuator (28) can be changed, in terms of its length, electrically, hydraulically and/or mechanically.

22. The folding pick-up attachment (10) according to claim 1, wherein the at least one actuator (28) can be controlled and/or regulated electrically and/or hydraulically, preferably from a central location, preferably from the driver station of the harvesting machine.
